(19) United States
(12) Patent Application Publication
(10) Pub. No.: US 2014/0008883 A1
(43) Pub. Date: Jan. 9, 2014

(54) COMBINATION STROLLER AND EXERCISE SYSTEM

(71) Applicants: Laine Mihalchick Litman, New York, NY (US); Jacquelyn Alex Daudt, New York, NY (US)

(72) Inventors: Laine Mihalchick Litman, New York, NY (US); Jacquelyn Alex Daudt, New York, NY (US)

(21) Appl. No.: 13/543,787

(22) Filed: Jul. 7, 2012

(51) Int. Cl. B62B 7/04; A63B 21/02; A63B 21/008

(52) U.S. Cl. 280/47.38

(57) ABSTRACT

A baby stroller provides upper body exercise for a person while pushing the stroller. The stroller has:
a) a frame,
b) at least three wheels, with at least one forward wheel and at least two rearward wheels,
c) a baby seat and
d) a fixed upright handle attached to the frame and extending above the baby's seat.

There is also an exercising device positioned behind the baby seat and attached to the frame comprising:
e) a pair of handles;
f) each handle having an proximal gripping end and a length of structural material extending to a distal end of the handle;
g) a sliding or rotating system that provides a horizontal resistance component to movement of the handle as the handle moves forward relative to the frame; and
h) a separate sliding or rotating system attached to each handle.

### BACKGROUND OF THE INVENTION

1. Field of the Invention

The present invention relates to the field of child or infant strollers and such strollers in combination with exercise systems for the person pushing the stroller.

2. Background of the Art

Strollers are commonly used by people with young children as a safe and convenient way for transporting a child. The child may be taken on walks by a parent o guardian, thereby allowing both parent and child to enjoy the fresh air and surroundings.

Conventional strollers typically have a frame supported on a plurality of wheels, usually three or four or more wheels and a seat or frame to comfortably secure the child within a stroller canoe or cockpit. A fixed bar or handle usually extends from the frame, so that an adult can grip the handles and propel the stroller forward when walking or running.

Parents are increasingly concerned about staying fit and healthy through exercise. After giving birth, mothers are particularly interested in regaining their pre-birth conditioning. Walking a baby in a stroller has become an excellent way, particularly for new mothers, to stay fit and healthy, while at the same time spending time with the child.

In walking a baby in a stroller, the baby and the stroller become part of the workout. The adult can increase the workout by power walking or jogging with the baby in the stroller, or can decrease the workout by walking at a normal or slow pace.

One disadvantage with exercising using a conventional stroller is that little upper body workout can be achieved without placing torque against the stroller that can force it out of alignment over the wheels and destabilizing the stroller. Although the walking motion allows for cardiovascular and lower body workout, the fixed handle construction of a conventional stroller precludes any arm movement, and prevents any kind of significant upper body workout. Attempts to exercise the arms while walking a baby in a conventional stroller is both awkward and unsafe for the child.

U.S. Pat. No. 5,375,861 discloses a baby stroller which allows a jogger to bring a baby along while jogging. The invention comprises a flexible connector attached at one end to the stroller and the other end to the jogger's body. The stroller is either pushed in front or pulled from behind by the jogger.

U.S. Pat. Nos. 5,062,651 and 5,106,108 each disclose a device for towing a child from behind while jogging. The carriage is connected to the jogger's body by means of a tow bar, and the carriage is pulled from behind.

A still further disadvantage of these previously known strollers is that the user cannot engage in a meaningful upper body workout including resistance training to achieve toning. At most, the user can simply move his or her arms through air.

U.S. Pat. No. 5,674,165 (Cohen) attempts to address some of these limitations with an exercising device for use with a baby stroller of the type having a housing secured to the frame of a stroller, and an elongated arm pivotally attached at one end of the arm to the housing. The invention may further include an apparatus for preventing pivotal movement of the arm relative to the housing until a torsional force greater than a predetermined amount is applied to the other end of the arm. The housing is secured to the stroller frame by a pair of plates, each having a channel in one side. With the channels facing each other, the plates compressingly engage a portion of the stroller frame. The elongated arm is pivotally attached to the housing by a fixed cuff interposed within a movable cuff. The movable cuff further includes a driven member including an aperture through which the elongated arm is attached. The torsional force necessary to move the arm can be increased or decreased by rotating a knob attached to a threaded bolt which extends through the housing and a space defined by the engagement of the fixed and movable cuffs. A plurality of Belleville washers can compressingly engage a pair of bearing washers at eider end of the interior space. The baby stroller exercising device enables a user to obtain an upper body workout while walking a baby in a stroller.

U.S. Pat. No. 8,012,070 (James) describes an exercise apparatus includes a handle bar and a resistance assembly, coupled to the handle bar. The resistance assembly includes a housing having first and second opposed parts, and permitting movement of the handle bar about a rotational axis upon applying force to the handle bar. A resistance mechanism resists movement of the handle bar about the rotational axis. A screw, mounted lengthwise along the rotational axis, and engaging a threaded receptacle, adjustably compresses the spacing between the housing parts and modifies resistance to movement of the handle bar. One of the screw and the receptacle is coupled to an adjustment knob setting a user-defined resistance. A clamp, coupled to the housing, removably attaches the exterior of the first housing part to a member. A user grasps the handle bar and moves it by applying force corresponding to the resistance setting. The clamp can be utilized without operating the knob.

U.S. Pat. No. 7,309,071 (Michael) describes an exercise stroller device for exercising a user's arms, shoulders, and chest muscles while walking, strolling, or running with an infant is provided. The exercise stroller device comprises a base unit, a plurality of wheels secured to the base unit, and a seat secured to the base unit with the infant receivable within the seat. A first handle is pivotally mounted to the base unit and a second handle is pivotally mounted to the base unit opposite the first handle. A resistance mechanism is releasably secured between the first handle and the second handle with the resistance mechanism providing resistance of movement between the first handle and the second handle wherein the first handle and the second handle are in a first position, wherein the first handle and the second handle are movable in a generally outward direction relative to each other against the resistance of the resistance mechanism to a second position, and wherein the first handle and the second handle automatically return to the first position.

U.S. Pat. No. 7,328,906 (Berkovich) describes a stroller with an upper body exercise system for the pusher that provides propulsion to the stroller through gearing from the upper body exercise system. A stroller apparatus is shown for exercising the arms and a portion of an upper torso of a user includes a seat to receive and support a rider. A frame is coupled to the seat to support the seat in an elevated position above a ground surface. A plurality of wheels is coupled to the frame. A crankshaft is rotatably coupled to the frame and releasably engages a pair of the wheels. The crankshaft rotates the associated pair of the wheels when the crankshaft is rotated with respect to the frame and engages the associated pair of the wheels. A pair of handle assemblies is operationally coupled to the crankshaft and pivotally coupled to the frame. One of the handle assemblies pivots in a direction opposite the other one of the handle assemblies in a substantially scissor like motion to rotate the crankshaft with respect to the frame.

U.S. Pat. No. 6,722,689 (Kreamer) describes a jogging stroller for carrying a baby that includes three wheels mounted on a frame that holds a cloth seat and includes frame rails that project upwardly and rearwardly from a single front wheel to a horizontal handlebar member at the rear of the stroller. A pair of handles are attached to the handlebar members by a clamp and these include a stem member that extends outwardly from the stroller handlebar and are connected to a perpendicular handle element that can rotate about the stem member and the stem members can be rotated about the axis of the horizontal stroller handlebar and can be slid along the handlebar. The handle elements can be fixed in space in a position desired by the user or can be left loose enough to rotate during use. The handle elements have a coil spring inside a grip member, allowing the handles to flex as the user jogs, thereby permitting more natural motion of the hands and shoulders during jogging.

U.S. Pat. No. 6,196,947 (Anderson) describes a jogging exercise stroller having a pair of pivotally connected arms. A user encounters greater resistance pivoting the arms in the direction of motion of the stroller than pivoting the arms in the opposite direction. The structure proposed by the prior art is not believed to be capable of meeting the safety and quality of exercise required by users. The carriage device has a frame, a locomotion means connected to said frame, and a propulsion means for use by a person at a rearward end of said frame for pushing said stroller in a forward direction, said propulsion means including one or more arms pivotally connected to said frame for movement in the forward and rearward directions and one or more resistance means for resisting movement of said one or more arms, said resistance means providing greater resistance against movement of said one or more arms in the forward direction than against movement of said one or more arms in the rearward direction.

### SUMMARY OF THE PRESENT INVENTION

A stroller is provided with two sets of independently operating or reciprocally operating exercise handles that are gripped by the stroller operator while pushing the stroller. By moving the handles against resisting pressure, upper body exercise is provided to the user. The orientation, vectors and positioning of the handles and the points and vectors at which forces are transmitted from the handles to the stroller body should be executed to reduce misaligning or destabilizing torque around the stroller body.

Various exercise systems are provided that allows upper arm and under body resistance to be achieved by the user. Various ones of the systems can be used while reducing destabilizing rotational torque being applied to the stroller. The strollers may also be collapsed according to various collapsible structures presently available.

### BRIEF DESCRIPTION OF THE FIGURES

FIG. 1 shows a Prior Art Figure of a collapsible stroller with upper body exercise capability according to U.S. Pat. No. 6,196,947 (Anderson).

FIG. 2 shows a Prior Art Figure of a collapsible stroller with upper body exercise capability according to U.S. Pat. No. 5,674,165 (Cohen).

FIG. 3 shows a top view of a slide assembly for providing upper body resistance when attached to a stroller. The assembly is shown with parallel slide movement on both sides of the assembly.

FIG. 4 shows a top view of a slide assembly for providing upper body resistance when attached to a stroller. The assembly is shown with slide movement angled inwardly from both sides of the assembly.

FIG. 5 shows a cutaway top view of a single piston.

FIG. 6A is a perspective view of an exercise jogging stroller according to the present technology.

FIG. 6B is a side view of a rotating handle member and intermediate resistance element.

FIG. 7 is a side view of individual alternatives of rotating or shifting handle members with intermediate resistance elements.

### DETAILED DESCRIPTION OF THE INVENTION

The following definitions will be of assistance in understanding aspects of the present technology as they relate to strollers, exercise strollers and components of an exercise stroller system.

“Forward” with respect to a stroller is a linear direction in which a stroller ordinarily moves when pushed by a person.

“Rearward” with respect to a stroller is a linear direction opposite to forward.

“Wheel separation” is the distance between a pair of wheels, the pair located at the forward end of the stroller or the rearward end of the stroller.

“Wheel separation axis” is the axis along which an axel connects a wheel pair at the forward of rearward end of the stroller.

“Torque-induced rotational instability” is a destabilizing force applied from the rear of the stroller while pushing it that has a propensity to rotate the stroller parallel the ground on which it is moving.

The present technology may be combined with essentially any prior art underlying stroller designs. The underlying structure of rigid strollers, collapsible structures, hybrid structures and the like may be used as an underlying structure over which the novel upper body exercise technology of the present invention may be superimposed. In fact, a retrofitting system is also described herein that can be attached to pre-existing strollers without significant upper body exercise capability. Underlying collapsible stroller structures such as those described in U.S. Pat. No. 5,674,165 (Cohen); U.S. Pat. No. 8,193,650 (Thorne); U.S. Pat. Nos. 8,186,706; 7,775,547 and 8,056,921 (Dotsey); U.S. Pat. No. 8,172,254 (Park); U.S. Pat. No. 8,087,689 (Fritz); U.S. Pat. No. 7,909,353 (Nolan); U.S. Pat. Nos. 7,871,100 and 6,908,101 (Chen); U.S. Pat. No. 7,766,366 (Li); U.S. Pat. No. 7,527,283 (Horacec); U.S. Pat. Nos. 7,410,187 and 7,404,569 (Hartenstein); U.S. Pat. No. 7,267,359 (Yang); U.S. Pat. No. 7,163,228 (Faber); U.S. Pat. No. 6,854,758 (Hon); U.S. Pat. No. 6,742,802 (Maxisch); U.S. Pat. No. 6,626,451 (Song); and the like. These collective disclosures are incorporated by reference in their entirities herein and the collectively evidence a state of the background of the invention for a generic concept of a collapsible stroller.

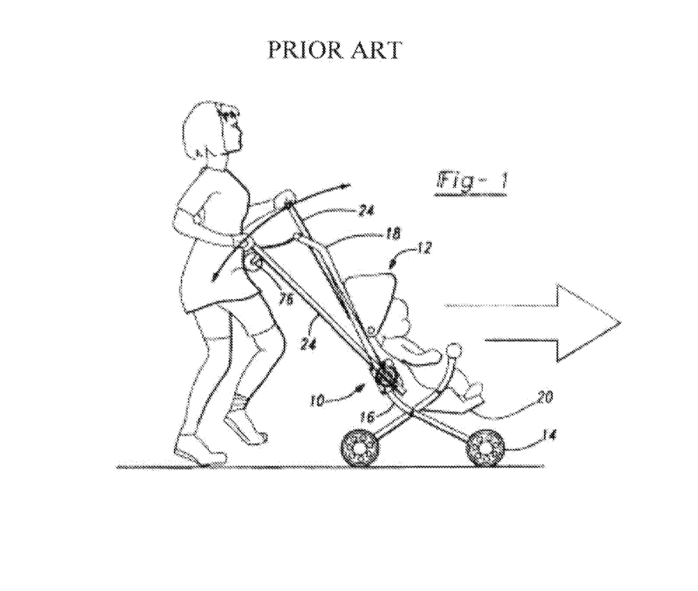

FIG. 1 illustrates a perspective view of a first Prior Art embodiment of a stroller of the present invention, generally designated 10, being operated by a person (not shown). The stroller 10 comprises a frame 12, having a handle section 14 and a support section 15, a seat 16 attached to the frame 12, a pair of resistance elements 24, wheels 26 connected to the frame 12, and a pair of exercise arms 18 each having a top end 20, a bottom end 22, and a pivot point 25. Each exercise arm 18 is pivotally connected to one side of the handle section 14 at pivot point 25 and is connected at its bottom end 22 to one end of the resistance element 24. The opposite end of each resistance element 24 is connected to one side of the support section 15 of the frame 12. A stopper (not shown) prevents the exercising arms 18 from pivoting beyond the position of the handle section 14 of the frame 12. Exercise arms 18 may be folded down, so as to lie parallel to the frame 12, when ordinary use of the stroller 10 is desired.

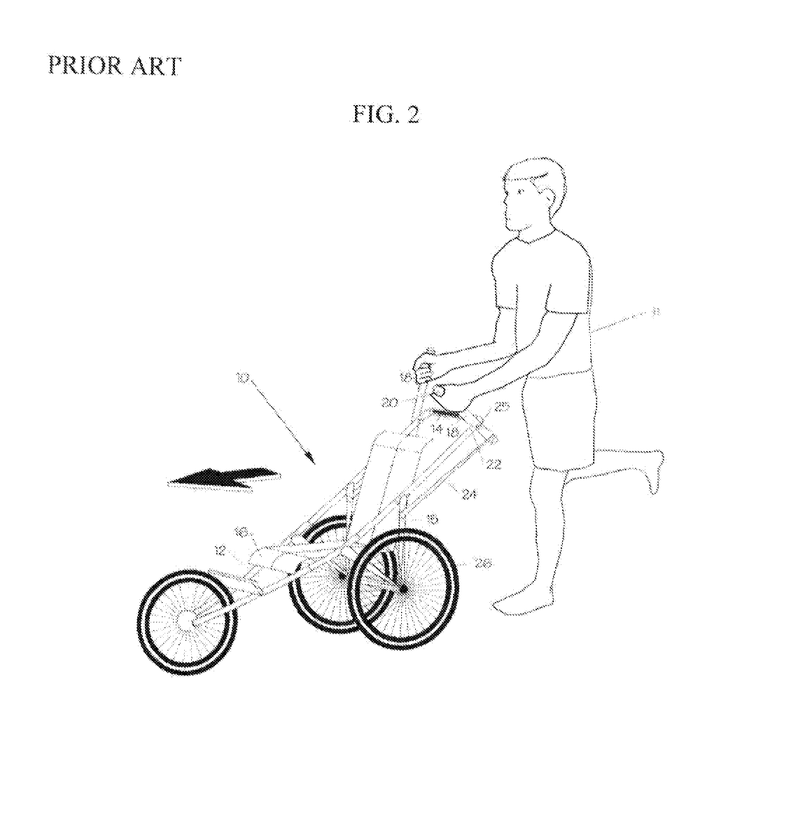

With reference first to FIG. 2, an illustration of a Prior Art embodiment of an exercising device 10 for use with a baby stroller 12 of the present invention is there shown. The baby stroller 12 can be of the conventional type having a plurality of wheels 14, and a frame 16. A fixed handle 18 may extend upwardly from the frame 16. The child is secured within a seat 20 attached to the frame 16.

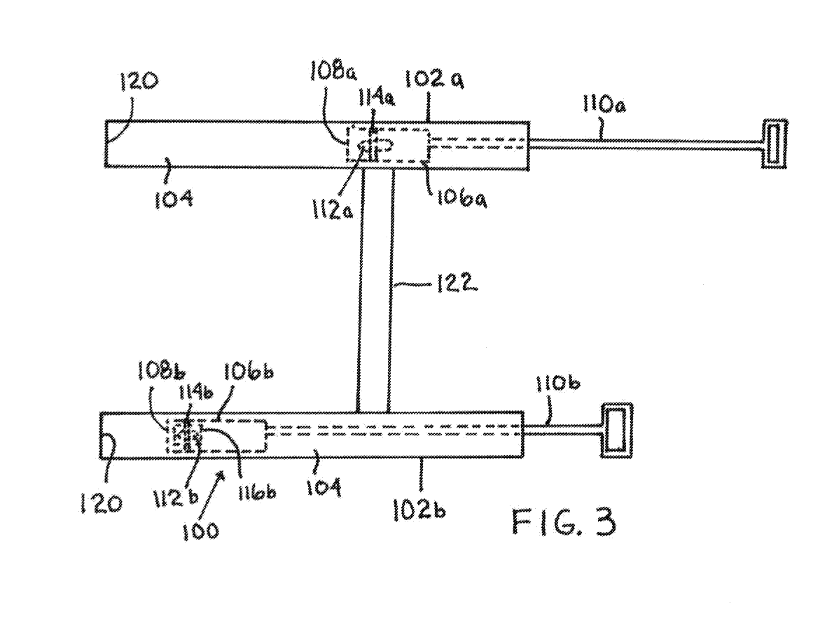

FIG. 3 shows a top view of a slide assembly 100 for providing upper body resistance when attached to a stroller (not shown). The assembly 100 is shown with parallel slide movement on both sides of the assembly 100. The slide assembly 100 has separate resistance housings 102a 102b, each separate resistance housing 102a 102b having a stable internal chamber 104 and a sliding resistance piston 106a 106b. The piston 106a (for example) may create resistance against movement (which is felt through handles 110 pressing the piston 106) may be generated by sliding (kinetic) friction, pneumatic pressure, spring pressure, elastic resistance, and roller resistance. The last form of resistance is shown in FIG. 3 where the forward end 108 of the piston 106 has a wheel 112 secured to the forward end 108 by a an axel 114 securing the wheel 112 onto the piston 106. The wheel 112b is shown extending out of a slot 116b in a bottom side of the piston 106. In alternative constructions there might be multiple wheels on the piston or the wheel may be forward of the piston and act as a buffer against the piston striking a far wall 120 within the chamber 104. Handle 110b is shown in a more forward position than handle 110a, indicating that the hand and arm of the user would likely be more extended on the side of the slide assembly 100 where handle 110b is present. A stabilizing system 122 is shown as a bar, but it may be more substantive with cross braces and the like used.

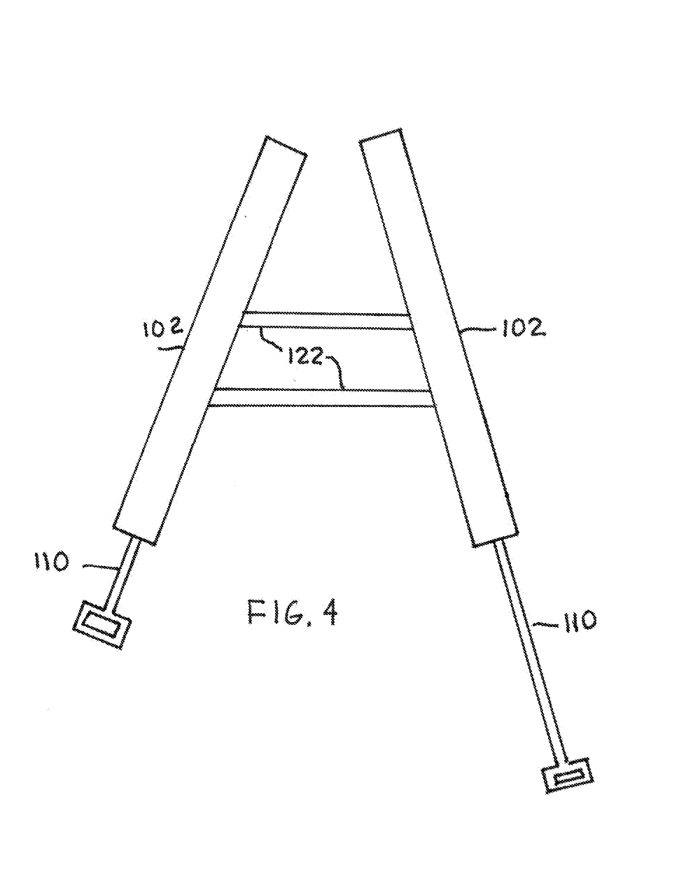

FIG. 4 shows a simplified top view of a slide system 100 in which the handles 110, separate resistance housings and the like are angled inwardly from the rear to the front of the stroller to again minimize torque-induced rotational instability by having vector forces transmitted through the handles avoid directly rotating an wheel relatively adjacent the handle being rotated outwardly. By being able to apply a force to an opposed handle, while the inwardly driven handle is being extended by the user, better stroller stability can be achieved, whatever the mechanism of resistance being applied internally in the slide assembly.

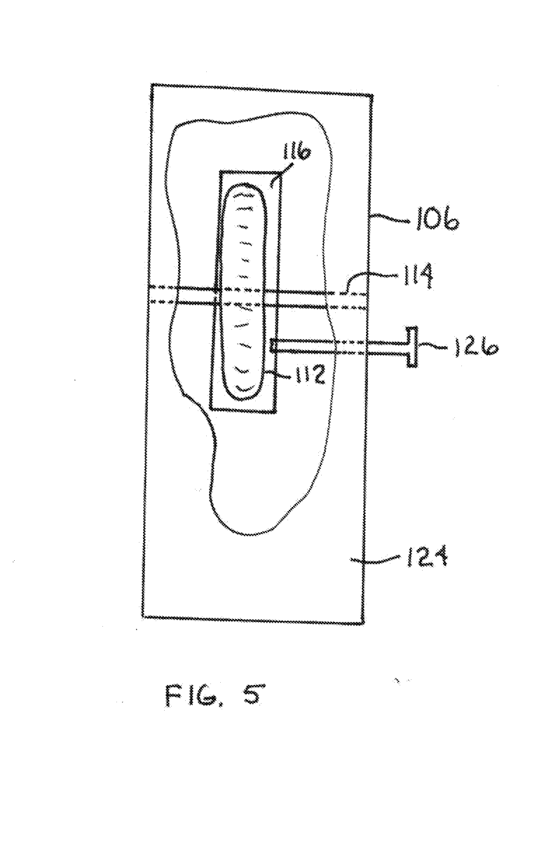

FIG. 5 shows a cutaway top view of a single piston 106. The wheel 112 is shown extending through a slot 116 on the far side of the piston 106. The top side 124 of the piston is cutaway to expose other elements. The axel 114 about which the wheel 112 freely rotates is shown. A locking pin 126 extending into the piston to restrain is shown. This may be activated outside of the slide assembly by remote control or additional manual controls (not shown). A pin, brake, toggle, lock (not shown) or other locking element may engage the wheel(s), the axel, the piston external walls, the handle or other element within the system to prevent the sliding mechanism from sliding and thereby maintaining the stroller as a more conventional, non-exercise format stroller.

The wheels and/or pistons may be locked so that there is no sliding and no movement of the handles. This will convert the stroller into a non-exercise stroller, at least a stroller with no specific upper body strengthening movements.

As pressure applied by the hands and arms of the person pushing the stroller assembly drives the piston 106 forward within the chamber 104, one arm extends forward and the opposing arm retracts rearwardly, withdrawing the piston 106 in the opposed chamber 104. It is desirable to position the chambers and pistons so that forces transmitted through the handles and pistons into the stroller assembly avoid torque-induced rotational instability being imposed on the stroller.

Any support point at the forward end of the slide assembly 100 that transfers force to the stroller should be positioned such that the vector of the force is within the wheel separation dimensions and preferably is within the middle 70%, more preferably within the middle 60% and most preferably within the middle 50% of the total distance within the wheel separation. This orientation of forces applied to the frame of the stroller reduces torque and rotational forces that could skew forces against the wheels of the stroller, lift one or more wheels off the ground, or twist the stroller frame beyond elastic limits of the materials of the stroller.

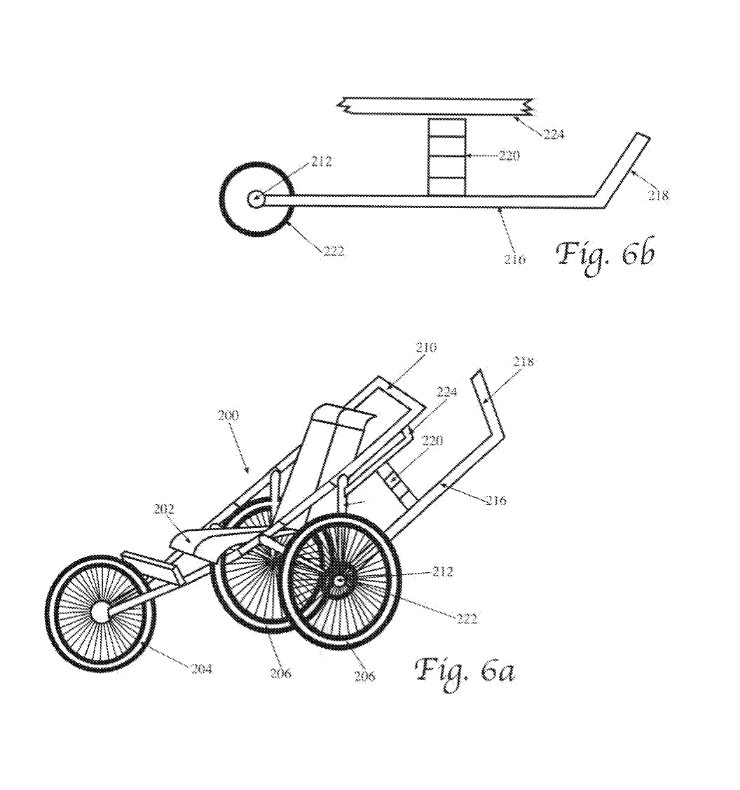

FIG. 6A shows a perspective view of an exercise jogging stroller 200. There is a structure shown with a single forward wheel 204 and two rear wheels 206. A seat 202 is within the stroller 200. A conventional handle bar 210 is shown. To the underlying structure is shown a rotating handle 216 with a grip 218 and an intermediate resistance element 220 which abuts a resistance bar 224 attached to the handle bar 210. The rotating handle 216 is attached to an axle 212 between the two rear wheels 206 by an rotating attachjment element 222 on the axle 212. As the handle 216 rotates up, the resistance element 220 is compressed and forces are transitted to the stroller 200 so that the stroller is propelled forward. There would be two handles 216 and two Resistance elements 220 for the left and right sides, but only one is shown for simplifying the figure. The handles would be operated cyclically and in opposition to both balance the stroller 200 and to alternately extend and retract arms of the jogger while running. The alternate extension/retraction would also tend to maintain forces against the stroller 200 to stabilize it. As can be seen in FIG. 1 and FIG. 2 of the prior art, neither construction enables steady pressure to be transmitted with a significant horizontal component by the free-moving arm grips. Therefore, very little control over the stroller movement is possible without applying rotational torque to the handles themselves. The present structure overcomes that significant problem through the intermediate resistance elements 220.

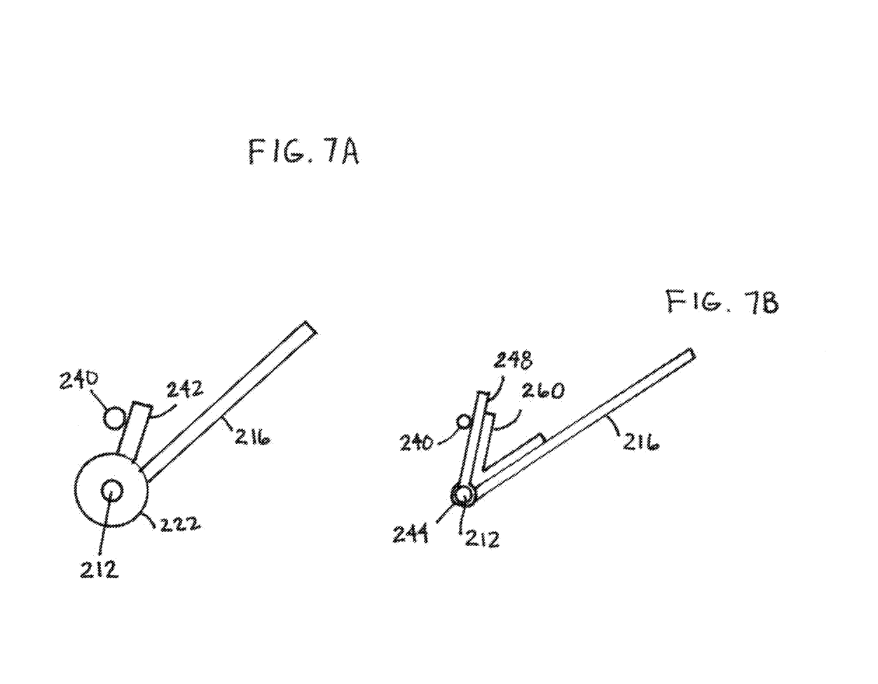

FIG. 6B shows a side view of a complete handle assembly having the axle 212 from the stroller, the rotating attachment element 222 rotatably connecting the handle 216 and grip 218 to the axle 212 so that the handle 216 rotates freely about the axle 212. The intermediate resistance device (between the grip and the axle, preferably at least 10%, at least 20%, at least 30% or more separated from the axle 212 along the length (as 100%) of the handle 216. The resistance device is able to compress and offer resistance through cushioning (elastic resistances), pneumatic movement through a piston as described herein, of by offering a living hinge (see FIG. 7) between the handle 218 and another attaching element (see FIG. 7). The compressible element 220 allows for separation of the compressible element 220 from a resistance bar 224 so that when the handle has been removed from transmitted contact with the resistance bar 224, returning it to contact will offer some cushioning resistance, as would not be the case if a metal (for example) handle 216 slammed into the frame of the stroller 200. The cushioning element therefore offers two functions as a shock reducing element and preferably also as an exercising element where controlled resistance can be provided.

The cushioning element 220 (which could be a pneumatic element, elastic element, compressible foam, spring in a piston, etc.) is shown with a separation distance between the resistance bar 224, showing that in a retracting direction of the arms, the separation can be provided, so that troque against the stroller counter to that being provided by the extending arm against a handle is not imposed. By reducing same rotation torque against the stroller, so that essentially only one arm is providing force to the stroller at any time, the entire stroller system is more stable, yet there is solid control over the stroller by the one extending arm once resistance is met.

FIG. 7A shows a side view of a single handle cushioning/exercising system comprising a handle 216, the axle 212, the rotating wheel attachment 222, a resistance bar 240 (which is shown parallel to the axle 212, but may be a single piece, not an extended bar), and a flexible elastic element 242 that bends and offers resistance and extensibility when the handle 216 is pressed forward. The resistance bat=r may be a single elastomeric or rubber post that is inserted into a hole (not shown) in the rotating wheel attachment 222, so that resistance can be adjusted by the composition and size of the element 242 or can be easily replaced when worn out by use. FIG. 7B shows a side view of a single handle cushioning/exercising system comprising a handle 216, the axle 212 and a connecting element 244 that allows the bracing bar 248 and the handle 216 to be independently moveable with respect to the axle 212. At the same time, a living hinge resistive element 260 is placed and secured (by adhesive, snaps, fitted engagement, pins, screws, etc.) to at least the handle 216 or the bracing bar 248 so that when the handle 216 is pressed forward, the living hinge 260 reduces its internal angle and offers resistance to extension and provides force against the stroller through the resistance bar 240. The living hinge may remain attached to one or both of the handle 216 and/or the bracing bar 248. These two sub-assemblies offer the cushioning and resistance features and control over stroller stability that is missing from prior art constructions.

The stroller may be variously described as a baby stroller providing upper body exercise for a person while pushing the stroller. The stroller may have:
a) a frame,
b) at least three wheels, with at least one forward wheel and at least two rearward wheels,
c) a baby seat and
d) a fixed upright handle attached to the frame and extending above the baby's seat,

an exercising device positioned behind the baby seat and attached to the frame comprising:
a) a pair of handles;
b) each handle having an proximal gripping end and a length of structural material extending to a distal end of the handle about which the length of structural material pivots;
c) a pivoting system at the distal end of the handle;
d) each handle of the pair of handles attached to a physical resistance system;
e) a resistive system that provides physical resistance to each of the handles when one of the handles is moving forward and provides forward propulsive force to the stroller during provision of the physical resistance;
f) the resistive system providing force to the handle from a point along the length of the structural material between the gripping end and the pivoting system.

The stroller may have as the resistive system i) a pneumatic piston that compresses air to provide resistance; ii) an elastic compressible material; or an elastic component with a living hinge or fold.

The baby stroller providing upper body exercise for a person while pushing the stroller may also be described as:
a) a frame,
b) at least three wheels, with at least one forward wheel and at least two rearward wheels,
c) a baby seat and
d) a fixed upright handle attached to the frame and extending above the baby's seat,

an exercising device positioned behind the baby seat and attached to the frame comprising:
e) a pair of handles;
f) each handle having an proximal gripping end and a length of structural material extending to a distal end of the handle;
g) a sliding system that provides a horizontal resistance component to movement of the handle as the handle slides forward relative to the frame;
h) a separate sliding system attached to each handle.

The baby stroller providing upper body exercise for a person while pushing the stroller may also be describes as having:
a frame,
at least three wheels, with at least one forward wheel and at least two rearward wheels,
a baby seat and
a fixed upright handle attached to the frame and extending above the baby's seat; wherein the stroller further comprises an exercising device positioned behind the baby seat and attached to the frame comprising:
a pair of handles;
each handle having an proximal gripping end and a length of structural material
extending to a distal end of the handle;
a sliding or rotating system that provides a horizontal resistance component to movement of the handle as the handle moves forward relative to the frame; and
a separate sliding or rotating system attached to each handle.

The various moving elements of the handles and resistive system and resistive component and sliding resistance may be provided with locks, blocks, clips, toggles or the like to restrict or prevent movement. In this way the stroller may have the exercise function disabled.

These sub-assemblies cause the forces to be removed (at least in part) from the axle, so that greater stability is provided by the system.

1. A baby stroller providing upper body exercise for a person while pushing the stroller, the stroller comprising:
a) a frame,
b) at least three wheels, with at least one forward wheel and at least two rearward wheels,
c) a baby seat and
d) a fixed upright handle attached to the frame and extending above the baby's seat, an exercising device positioned behind the baby seat and attached to the frame comprising:
e) a pair of handles;
f) each handle having an proximal gripping end and a length of structural material extending to a distal end of the handle about which the length of structural material pivots;
g) a pivoting system at the distal end of the handle;
h) each handle of the pair of handles attached to a physical resistance system;
i) a resistive system that provides physical resistance to each of the handles when one of the handles is moving forward and provides forward propulsive force to the stroller during provision of the physical resistance;
j) the resistive system providing force to the handle from a point along the length of the structural material between the gripping end and the pivoting system and the point being located to provide a force with a direction passing between the two rearward wheels so as to not provide a torque against the stroller that can force it out of alignment over the wheels and destabilizing the stroller.

2. The stroller of claim 1 wherein the resistive system comprises a pneumatic piston that compresses air to provide resistance.

3. The stroller of claim 1 wherein the resistive system comprises an elastic compressible material.

4. The stroller of claim 1 wherein the resistive system comprises an elastic component with a living hinge.

5. A baby stroller providing upper body exercise for a person while pushing the stroller, the stroller comprising:
a) a frame,
b) at least three wheels, with at least one forward wheel and at least two rearward wheels,
c) a baby seat and
d) a fixed upright handle attached to the frame and extending above the baby's seat, an exercising device positioned behind the baby seat and attached to the frame comprising:
e) a pair of handles;
f) each handle having an proximal gripping end and a length of structural material extending to a distal end of the handle;
g) a sliding system that provides a horizontal resistance component to movement of the handle as the handle slides forward relative to the frame;
h) a separate sliding system attached to each handle so that the sliding system is located to provide a force with a direction passing between the two rearward wheels so as to not provide a torque against the stroller that can force it out of alignment over the wheels and destabilizing the stroller.

6. A baby stroller providing upper body exercise for a person while pushing the stroller, the stroller comprising:
a frame,
at least three wheels, with at least one forward wheel and at least two rearward wheels,
a baby seat and
a fixed upright handle attached to the frame and extending above the baby's seat;
wherein the stroller further comprises an exercising device positioned behind the baby seat and attached to the frame comprising:
a pair of handles;
each handle having an proximal gripping end and a length of structural material extending to a distal end of the handle;
a sliding or rotating system that provides a horizontal resistance component to movement of the handle as the handle moves forward relative to the frame; and
a separate sliding or rotating system attached to each handle so that each sliding or rotating system is located to provide a force with a direction passing between the two rearward wheels so as to not provide a torque against the stroller that can force it out of alignment over the wheels and destabilizing the stroller.

7. The stroller of claim 6 wherein the resistive component comprises a pneumatic piston that compresses air to provide resistance.

8. The stroller of claim 6 wherein the resistive component comprises an elastic compressible material.

9. The stroller of claim 8 wherein the resistive component comprises an elastic component with a living hinge.
